(19) United States
(12) Patent Application Publication
(10) Pub. No.: US 2014/0237552 A1
(43) Pub. Date: Aug. 21, 2014

(54) AUTHENTICATING MEDIUM, AUTHENTICATING TERMINAL, AUTHENTICATING SERVER, AND METHOD FOR AUTHENTICATION BY USING SAME

(71) Applicant: Seung Hun YOO, (US)

(72) Inventor: Seung Hun YOO, Seoul (KR)

(21) Appl. No.: 14/347,234

(22) PCT Filed: Sep. 19, 2012
(86) PCT No.: PCT/KR2012/007506

§ 371 Date: Mar. 25, 2014

(30) Foreign Application Priority Data
Sep. 26, 2011 (KR) 10-2011-0096958

(51) Int. Cl. H04L 29/06

(52) U.S. Cl. CPC H04L 63/08
USPC 726/3; 726/7

(57) ABSTRACT

The present invention relates to an authenticating medium, an authenticating terminal, an authenticating server, and a method for authentication by using same. According to the present invention, an operating code for creating an authentication requesting code is periodically updated, and thus the authentication requesting code is also periodically changed. Thus, even if the authentication requesting code or the operating code exchanged through networks is leaked to other users, the security of an account may be maintained, and thus the security may be enhanced. In addition, even if users do not remember authentication codes for granting authorization, the codes recorded in an authentication medium are periodically updated and automatically authenticated, and which may prevent damages that may occur when users forget the authentication codes or the authentication codes are set using numbers that are easy to memorize.

### TECHNICAL FIELD

The present invention relates to an authentication medium, an authentication terminal, an authentication server, and an authentication method using the same and, more particularly, to an authentication medium, an authentication terminal, an authentication server and an authentication method using the same, which enable security to be maintained even when authentication-related information exchanged between a server and a terminal are intercepted.

### BACKGROUND ART

Recently, of various types of business methods, on-line services utilizing networks, such as the Internet, have attracted attention. Such on-line services are performed through a server using terminals possessed by users as clients and a wired/wireless network that enables the exchange of data between the server and the clients. In such on-line services, separate services are provided to distinctive users, personalized services are generated so that the content of a service provided to each user is not exposed to another user, and the right to access the personalized service is not allowed another user. For this purpose, a user account and an authentication code for accessing the user account are assigned to each user, and the right of the user is authenticated using the ID information of the user account and the authentication code. Such a conventional authentication method is disclosed in Korean Patent Application Publication No. 2003-0055084. However, this method has a problem in that data exchanged over a wired/wireless network in such an authentication process may be easily exposed to others.

### DISCLOSURE

### Technical Problem

Accordingly, the present invention has been made keeping in mind the above problems occurring in the prior art, and an object of the present invention is to provide an authentication medium, an authentication terminal, an authentication server, and an authentication method using the same, which are capable of maintaining the security of a user account even when data exchanged over a network is exposed to another person.

Another object of the present invention is to provide an authentication medium, an authentication terminal, an authentication server, and an authentication method using the same, which are capable of performing authentication even when a user does not remember an authentication code that is used to have his or her right authenticated.

A further object of the present invention is to provide an authentication medium, an authentication terminal, an authentication server, and an authentication method using the same, which are capable of minimizing accessibility to a corresponding user account even when an authentication code is exposed to another person.

Yet another object of the present invention is to provide an authentication medium, an authentication terminal, an authentication server, and an authentication method using the same, which are capable of enhancing a security stage but minimizing a procedure to be taken by a user.

### Technical Solution

In order to accomplish the above objects, the present invention provides an authentication server for exchanging data with a plurality of terminals over a network and authenticating a right to access an account in response to a request from the terminal, the authentication server including an authentication unit for computing an authentication code using a predetermined function using one or more operation codes recorded on an operation code list as independent variables when an authentication request for a specific account is received from the terminal, comparing the computed authentication code with an authentication request code included in an authentication request received from the terminal, and authenticating a right to access the specific account only if the computed authentication code is identical to an authentication request code; a code generation unit for generating one or more new operation codes whenever the authentication unit performs a predetermined number of authentications on the specific account and sending the one or more new operation codes to the terminal that has requested the authentication; and a code management unit for recording the generated operation codes on an operation code list of the corresponding account when the new operation codes are generated by the code generation unit and selectively deleting at least some of existing operation codes if necessary.

In this case, the operation code may be x, x being a character string including one or more of numbers and alphabetical letters, the authentication request code may be y, and the function may be y=x.

The predetermined number of authentications may be 1.

The operation codes may be two or more in number, and the function may be a function for selecting one from among the two or more operation codes.

In this case, the authentication server may further include a transmission and reception unit for encoding the operation codes newly generated by the code generation unit, sending the encoded operation codes to the terminal, receiving the authentication request code encoded and transmitted by the terminal, and decoding the received authentication request code.

The code management unit may match the operation codes, included in the operation code list, with the respective independent variables included in the function, may assign a predetermined sequential position to each of the independent variables, and may sequentially match the operation codes with the respective independent variables according to a predetermined sequence whenever a new operation code is generated.

Additionally, the present invention provides an authentication medium for accessing a terminal provided with an authentication service by an authentication server and authenticating a right to access an account, the authentication medium including an interface for exchanging data with the terminal and receiving one or more new operation codes when the one or more new operation codes are transmitted by the authentication server through the terminal; memory for storing an operation code list in which one or more of the operation codes received through the interface are sequentially recorded; and a microcomputer for computing an authentication request code using a function using the one or more operation codes included in the operation code list stored in the memory as independent variables and sending the computed authentication request code to the authentication server through the interface; wherein the microcomputer records the one or more operation codes received by the interface in the operation code list and selectively deletes at least some of existing operation codes.

In this case, the operation code may be x, x being a character string including one or more of numbers and alphabetical letters, the authentication request code may be y, and the function may be y=x.

The authentication medium may be an integrated circuit card including an integrated processor and integrated memory.

The microcomputer may receive a password from the terminal, may compute the authentication request code using the function using the one or more operation codes included in the operation code list stored in the memory as the independent variables only if the received password is identical to a password stored in the memory, and may send the computed authentication request code to the authentication server through the interface.

The interface may encode the authentication request code, sends the encoded authentication request code to the terminal, and may decode the operation codes received from the terminal.

Additionally, the present invention provides an authentication terminal for being provided with an authentication service by an authentication server using data stored in an external storage medium, the authentication terminal including a communication unit for communicating with the authentication server, sending an authentication request to the authentication server when an authentication request command is input from a user, and receiving a new operation code from the authentication server; a connection unit for reading and writing data while communicating with the external storage medium, and causing an operation code to be recorded in an operation code list of the external storage medium in which one or more operation codes are sequentially recorded when the operation code is received from the authentication server; and a control unit for computing an authentication request code using a function using one or more operation codes included in the operation code list stored in the external storage medium as independent variables, and sending the computed authentication request code to the authentication server through the communication unit; wherein the control unit may record one or more operation codes received by the communication unit in the operation code list in order of reception, and may selectively delete at least some of existing operation codes if necessary.

Additionally, the present invention provides an authentication method in a system including an authentication medium for storing data required for authentication, a terminal for requesting authentication using an authentication request code generated based on the data stored in the authentication medium, and an authentication server for comparing the authentication request code with an authentication code in response to the request from the terminal and selectively performing an authentication procedure, the authentication method including (A) generating, by the authentication medium or the terminal, the authentication request code using a predetermined first function using operation codes included in a first operation code list stored in the authentication medium as independent variables; (B) sending, by the terminal, an authentication request, including the authentication request code, to the authentication server; (C) comparing, by the authentication server that has received the authentication request, an authentication code, generated using a second function identical to the first function and using operation codes included in a second operation code list stored in the authentication server as independent variables, with the authentication request code and selectively performing the authentication; (D) generating, by the authentication server, a new operation code if the authentication is successful in the authentication server, sending the new operation code to the terminal, recording an operation code identical to the new operation code transmitted by the terminal in the second operation code list in a time sequence in which the new operation code was generated, and simultaneously deleting an oldest operation code from the second operation code list; and (E) transferring, by the terminal that has received the new operation code from the authentication server, the received new operation code to the authentication medium, recording, by the terminal or the authentication medium, the new operation code in the first operation code list in a time sequence in which the new operation code was received, and selectively deleting at least some of existing operation codes from the first operation code list if necessary.

In this case, at step (D), the authentication server may use a character string generated by arranging a plurality of characters at predetermined digit positions, as the new operation code.

The number of operation codes recorded in each of the first and second operation code lists may be one or more and identically maintained, and each of the first and second functions may be a function for computing dependent variables by alternatively selecting any one of one or more independent variables or performing computation using at least some of the one or more independent variables.

Each of the first and second operation code lists may include a single operation code, and each of the first and second functions may be a function for computing the dependent variables identical to the independent variables using the single operation code as a single independent variable.

Each of the operation codes recorded on the first and second operation code lists may be recorded along with the time at which the operation code was recorded, and the method further include, before step (A), comparing the times at which the operation codes included in the first operation code list were recorded with the respective times at which the operation codes included in the second operation code list were recorded, and deleting operation codes having differences between the times recorded on the first and second operation code lists from the first and second operation code lists.

### Advantageous Effects

The authentication medium, the authentication terminal, the authentication server, and an authentication method using the same according to the present invention have the following advantages.

That is, an operation code for generating authentication request code is periodically updated and thus the authentication request code is also periodically changed. Accordingly, there is an advantage in that security can be enhanced because the security of a user account can be maintained even when the operation code or authentication request code exchanged over a network is exposed to another person.

Furthermore, in accordance with the authentication medium, the authentication terminal, the authentication server, and the authentication method using the same according to the present invention, a code recorded on the authentication medium is periodically updated and also automatic authentication is performed even when a user does not remember an authentication code that is used to have this or her right authenticated. Accordingly, there is an advantage of preventing damage that may occur when an authentication code is forgotten or an authentication code is set to numbers easy to remember. Since an authentication code does not need to be memorized, the number of digits of code may be increased to a large number.

In accordance with the authentication medium, the authentication terminal, the authentication server, and an authentication method using the same according to the present invention, there are advantages in that access to an authentication code by another person can be minimized because a different authentication code is used each time even when the authentication code is exposed to another person, and in that damage attributable to hacking can be minimized by taking subsequent countermeasures because whether or not a user account has been hacked can be checked based on whether or not an operation code list recorded on a server is identical to an operation code list recorded on the authentication medium.

Furthermore, in accordance with the authentication medium, the authentication terminal, the authentication server, and the authentication method using the same according to the present invention, there are advantages in that a security stage can be enhanced and a procedure to be taken by a user can be minimized and thus user convenience is increased because a two-step authentication procedure, that is, user password authentication and authentication via an operation code recorded on the authentication medium, can be performed even when a user remembers only a single password.

### DESCRIPTION OF DRAWINGS

FIG. 1 is a conceptual diagram schematically showing the general configuration of an authentication system according to an embodiment of the present invention;

FIG. 2 is a block diagram schematically showing the construction of an authentication medium according to an embodiment of the present invention;

FIG. 3 is a block diagram schematically showing the construction of an authentication terminal according to an embodiment of the present invention;

FIG. 4 is a block diagram schematically showing the construction of an authentication server according to an embodiment of the present invention; and

FIG. 5 is a flowchart illustrating in a stepwise manner an authentication method according to an embodiment of the present invention.

### MODE FOR INVENTION

An authentication medium, an authentication terminal, an authentication server, and an authentication method using the same according to embodiments of the present invention are described in detail below with reference to the drawings. The advantages and characteristics of the present invention and a method for achieving the advantages and the characteristics will become more apparent from embodiments described in detail later in conjunction with the accompanying drawings.

However, the present invention is not limited to the disclosed embodiments, but may be implemented in various ways. The embodiments are provided merely to complete the disclosure of the present invention and to allow those skilled in the art to understand the scope of the present invention. The present invention is defined only by the scope of the claims.

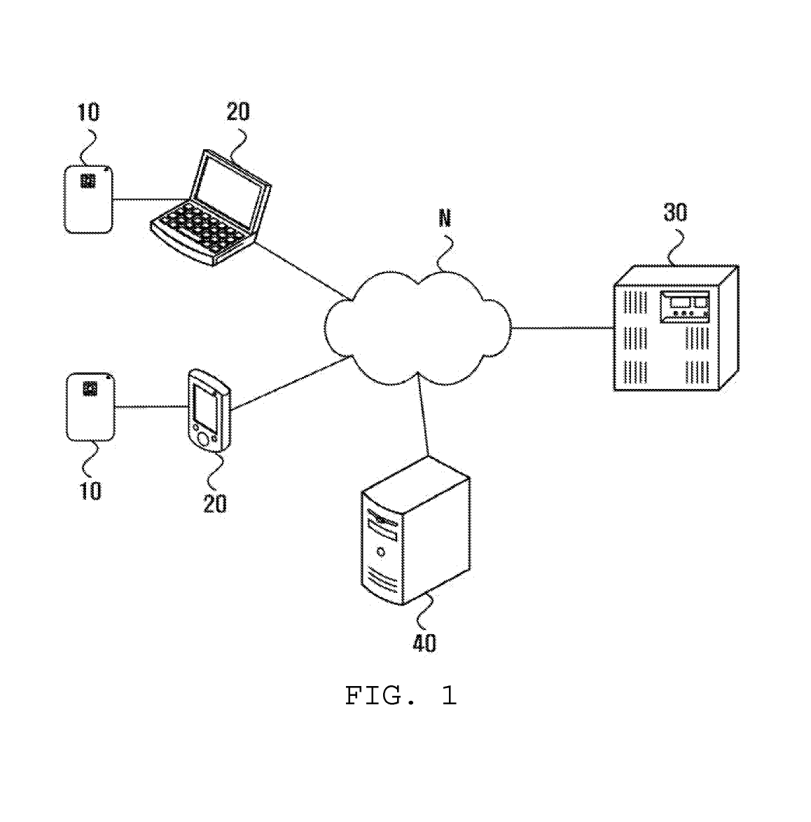

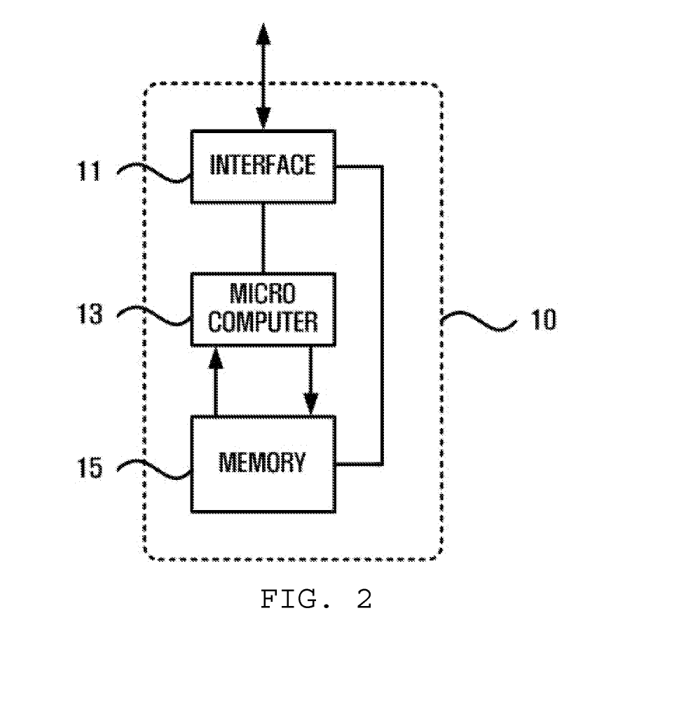

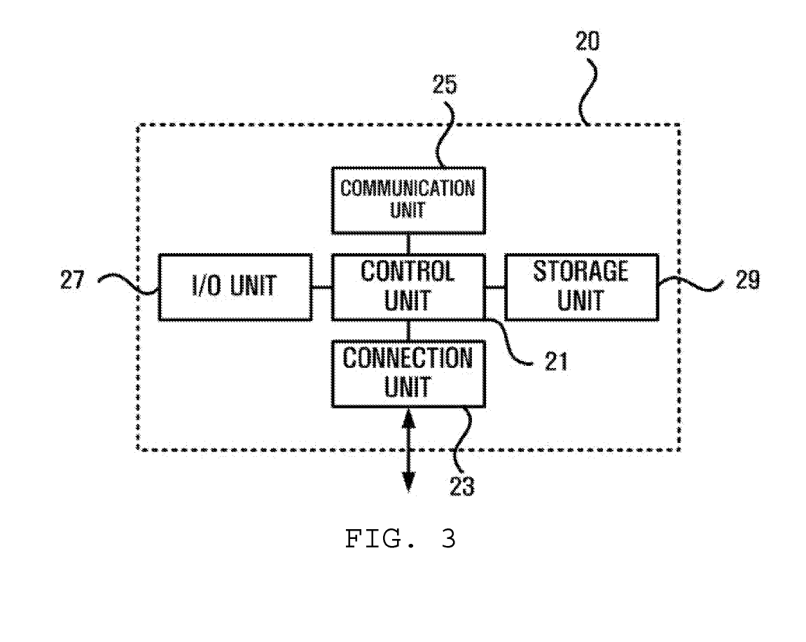

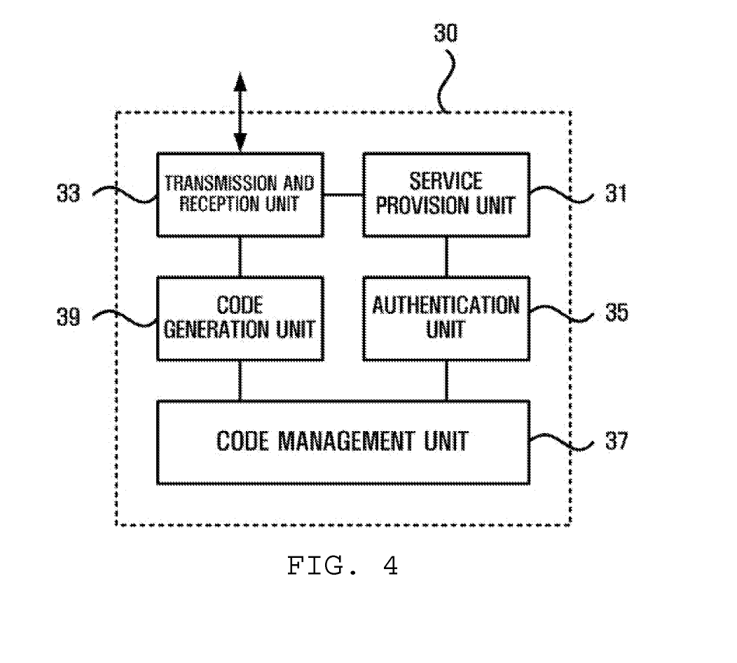

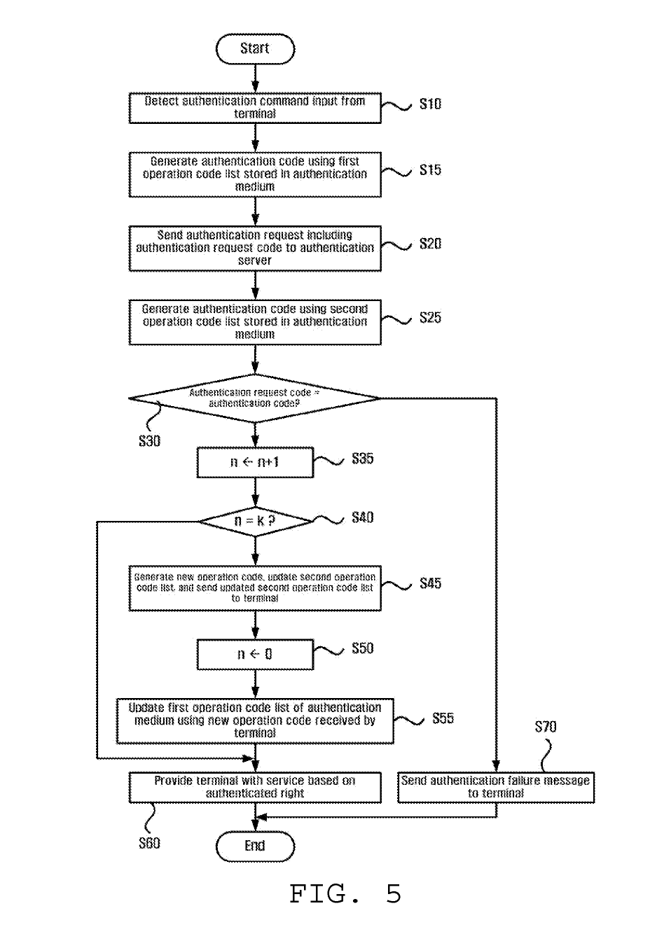

Throughout the specification, the same reference numbers will be used to refer to the same components. FIG. 1 is a conceptual diagram schematically showing the general configuration of an authentication system according to an embodiment of the present invention, FIG. 2 is a block diagram schematically showing the construction of an authentication medium according to an embodiment of the present invention, FIG. 3 is a block diagram schematically showing the construction of an authentication terminal according to an embodiment of the present invention, FIG. 4 is a block diagram schematically showing the construction of an authentication server according to an embodiment of the present invention, and FIG. 5 is a flowchart illustrating in a stepwise manner an authentication method according to an embodiment of the present invention.

As shown in FIG. 1, the authentication system according to an embodiment of the present invention includes the authentication medium 10 first. The authentication medium 10 includes an external storage medium that may be read and written using the terminal 20 to be described later.

The authentication medium 10 includes an interface 11, as shown in FIG. 2. The interface 11 is a connection means for exchanging data with the terminal 20, and includes a wired or wireless communication means. In some embodiments, the authentication medium 10 may be supplied with power by the terminal 20 through the interface 11.

Furthermore, data received by the interface 11 is delivered to and stored in memory 15. The memory 15 includes non-volatile memory that does not lose stored data even when the supply of power to the authentication medium 10 is blocked. In particular, the memory 15 stores data related to authentication, and provides data required when authentication is performed. The terminal 20 may directly write or read data into or from the memory 15 through the interface 11, or a microcomputer 13 to be described later may write or read data into or from the memory 15.

Furthermore, optionally, the authentication medium 10 may further include the microcomputer 13. The microcomputer 13 is an integrated microprocessor, and may read data stored in the memory 15 or write data into the memory 15 or directly perform an authentication procedure using data stored in the memory 15. Furthermore, the microcomputer 13 is driven by power received through the terminal 20, and may perform user authentication by comparing a password directly input by a user through the terminal 20 with a password stored in the memory 15.

The authentication medium 10 may be various types of external storage media that may be read and written, particularly an integrated circuit card including the microcomputer 13. Alternatively, the authentication medium 10 may be a flash drive based on a universal serial bus communication method, or various other types of external storage media.

Meanwhile, the terminal 20 which reads data from the authentication medium 10 and uses the read data in an authentication procedure is configured as shown in FIG. 3. The terminal 20 is an information processing device, such as a personal computer, a mobile communication terminal, a tablet computer, or an automatic teller machine, and is a client device which is able to communicate with a network and supplied with various types of services from servers present in a network. In an embodiment of the present invention, users access a network through the terminal 20, and perform an authentication procedure for having the rights to access their desired user accounts verified.

In this case, the authentication medium 10 is used. Users perform an authentication method according to an embodiment of the present invention in such a manner that the users install the authentication medium 10 in the terminal 20 so that the authentication medium 10 may exchange data with the terminal 20, read data recorded on the authentication medium 10, generate data requested by the authentication server 30 to be described later, and send the requested data to the authentication server 30.

For this purpose, the terminal 20 includes a control unit 21 first. The control unit 21 is a means responsible for overall control over the terminal 20, and performs the interpretation of instructions, the processing of data, operations, etc.

The control unit 21 communicates with the authentication medium 10 through a connection unit 23. The connection unit 23 connects with the interface 11 in a wired or wireless manner, forms a data exchange path, and may perform the encoding of data to be transmitted and the decoding of received data, if necessary. Furthermore, when the control unit 21 receives a data write instruction intended for the memory 15 of the authentication medium 10, the connection unit 23 may function to write data, that is, the object of the instruction, into the memory 15. In this case, the connection unit 23 may perform a data write function.

Furthermore, the control unit 21 exchanges data with the authentication server 30 to be described later through a communication unit 25. The control unit 21 accesses the authentication server 30 or another server 40 over a network N, and is supplied with various types of services. In this case, if the authentication of a specific user account is requested by the authentication server 30 directly or within a service provided by another server 40, the control unit 21 reads data recorded on the authentication medium 10 through the connection unit 23, generates an authentication request code, and requests authentication by sending the authentication request code to the authentication server 30 through the communication unit 25.

Furthermore, the terminal 20 is equipped with an input/output (I/O) unit 27. The I/O unit 27 includes an input means for receiving a command or data from a user and an output means for displaying the processing results of a command or data input from a user in an image form. Through the I/O unit 27, a user may select a desired service and a service selected by the user is provided.

Furthermore, a storage unit 29 included in the terminal 20 may store an application required to communicate with the authentication server 30, and may also store applications required to be provided with various types of services provided over the network N. In particular, in the case where an authentication request code is generated using data stored in the authentication medium 10, if the authentication medium 10 is equipped with the microcomputer 13, the microcomputer 13 may directly generate the authentication request code according to its settings, and may send the authentication request code to the authentication server 30 through the terminal 20. If the authentication medium 10 is not equipped with the microcomputer 13, the control unit 21 generates the authentication request code using data stored in the authentication medium 10 in accordance with an application stored in the storage unit 29.

Meanwhile, as shown in FIG. 1, in an embodiment of the present invention, when the terminal 20 is supplied with various types of services provided over the network N, the right to access a specific service is authenticated through communication with the authentication server 30. For example, if the terminal 20 is provided with a service by another server 40 other than the authentication server 30, the right of the terminal 20 is not directly authenticated by the other server when access to a specific user account is to be authenticated. Instead, the right of the terminal 20 may be authenticated through the authentication server 30, and another server 40 may receive the results of the authentication from the authentication server 30, so that whether or not the authentication is successful or unsuccessful is determined.

As shown in FIG. 4, the authentication server 30 may include a service provision unit 31 first. The service provision unit 31 is a component for generating data that is used to provide an authentication service or other services provided by the authentication server 30 to the terminal 20 or another server 40. For example, the service provision unit 31 may generate a message providing notification of a success or failure of authentication depending on the results of authentication as data in the case of providing an authentication service is to be provided, and may generate a message providing notification of the results of processing of a requested finance service as data in the case of providing a finance service.

Furthermore, the authentication server 30 includes a transmission and reception unit 33. The transmission and reception unit 33 functions to receive an authentication request from the terminal 20 or other servers 40 over the network N and to send service-related data, generated by the service provision unit 31, to the terminal 20 or other servers 40. Furthermore, when a new operation code is generated by a code generation unit 39 to be described later, the transmission and reception unit 33 functions to send the new operation code to the terminal 20.

The authentication server 30 further includes an authentication unit 35. The authentication unit 35 is a means for receiving an authentication request code included in an authentication request transmitted by the terminal 20, comparing the authentication request code with an authentication code corresponding to a user account whose authentication is desired by a user, and then authenticating the right of the user. The authentication unit 35 determines a success or failure of authentication based on the results of the comparison.

In this case, when comparing the authentication request code received from the terminal 20 with the authentication code, the authentication unit 35 uses codes recorded on a code management unit 37.

The code management unit 37 stores and manages various data that is used to authenticate the right to access each user account or other rights. In particular, an operation code that is used to authenticate each right is recorded on the code management unit 37. An operation code list including one or more operation codes is managed with respect to each right. Such an operation code may be an authentication code itself, and may be one or more independent variables used to compute an authentication code using a function. For example, when a new user account is generated, the code management unit 37 may generate a first operation code corresponding to the new user account, and may store the first operation code. Furthermore, when an authentication request intended for a corresponding user account is received, the code management unit 37 may generate an authentication code using the stored first operation code, and then the authentication unit 35 may determine authentication based on the generated authentication code. Alternatively, the code management unit 37 may previously generate and store an authentication code using the operation code list, and may provide the stored authentication code to the authentication unit 35 when the terminal 20 sends an authentication request intended for a corresponding user account. In this case, an operation code list identical to an operation code list first recorded on the code management unit 37 and a function identical to a function for generating the authentication code using the operation code may be recorded on the authentication medium 10 and issued to the operator of the authentication server 30. Alternatively, when a user generates a new user account through the terminal 20, the code management unit 37 may receive a list identical to an operation code list first recorded on the code management unit 37 and a function identical to a function for generating authentication code using the operation code through the transmission and reception unit 33 of the authentication server 30, and may first record the received list and function on the authentication medium 10.

Meanwhile, one or more operation codes included in an operation code list stored in the code management unit 37 are updated whenever an authentication procedure for a corresponding user account is successful, or are periodically updated when a predetermined number of authentication procedures are successful. For this purpose, when the authentication of a specific user account is successful, the code generation unit 39 checks whether or not a predetermined number of authentications have been successful, generates one or more new operation codes if a predetermined number of authentications have been successful, and transfers the generated one or more new operation codes to the code management unit 37. In this case, the operation codes are each generated in the form of a character string that includes one or more alphabetical letters and/or one or more numbers corresponding to a predetermined number of digits, and the alphabetical letters or numbers arranged at respective digit positions may be randomly extracted. Furthermore, the new operation codes generated by the code generation unit 39 are transferred to the code management unit 37, and are sequentially registered in the operation code list in a time sequence in which the new operation codes were generated. If a single new operation code is registered in the operation code list, the oldest single operation code is deleted. If two new operation codes are newly registered in the operation code list, the oldest two operation codes are deleted. Accordingly, the operation code list is updated with a specific number of operation codes included therein. This is only an embodiment. Accordingly, the operation code lists of the authentication medium 10 and the authentication server 30 may maintain a predetermined number of operation codes, and the number of operation codes that are actively recorded may be changed.

In this case, when generating new operation codes and transferring the new operation codes to the code management unit 37, the code generation unit 39 essentially sends the newly generated operation codes to the terminal 20 through the transmission and reception unit 33. In response thereto, the control unit 21 of the terminal 20 or the microcomputer 13 of the authentication medium 10 is registered in the memory 15. Accordingly, an operation code list identical to the operation code list of the code management unit 37 is managed in the memory 15 of the authentication medium 10, and the operation code list of the memory 15 is also updated when the operation code list of the code management unit 37 is updated. For this purpose, when new operation codes are received from the authentication server 30, the control unit 21 or the microcomputer 13 may be equipped with an application, firmware, etc. that has been programmed to newly update the operation code list stored in the memory 15 using the new operation codes. In this case, a method of updating the operation code list is the same as a method of the code management unit 37 updating the operation code list such that the operation code lists stored in the two components are identically maintained. Furthermore, a function used for the authentication unit 35 to compute an authentication code using the operation code list and a function used to compute an authentication request code using the operation code list recorded in the memory 15 are identically set, as described above. The corresponding function is recorded in the memory 15 of the authentication medium 10, and the control unit 21 of the terminal 20 or the microcomputer 13 of the authentication medium 10 may include an application or firmware that has been programmed to compute the authentication request code using the function recorded in the memory 15.

Furthermore, in this case, a function for determining the authentication code or the authentication request code using the operation code list may be set in various ways. The function is a function for computing a single new dependent variable using at least some of one or more operation codes included in the operation code list as each independent variable and determining the computed dependent variable to be an authentication code or an authentication request code.

As an example, the operation code list may be managed such that it includes only a single operation code, and the function may be a function for determining a unique operation code, included in the operation code list, to be an authentication code or an authentication request code. That is, assuming that a single operation code is an independent variable x and an authentication code or an authentication request code is a dependent variable y, the function becomes y=x.

As another example, the function may be a function for extracting any one code from an operation code list including a plurality of operation codes. For example, in the operation code list, sequentially stored operation codes may be designated as independent variables x1, x2, x3, x4 and x5, and one of the sequentially stored operation codes may be extracted as a dependent variable y and determined to be an authentication code or an authentication request code. In such a case, the function may be y=x3, for example.

As yet another example, in the operation code list, sequentially stored operation codes may be designated as respective independent variables x1, x2, x3 and x4, and a dependent variable y, that is, an authentication code or an authentication request code, is determined using all the sequentially stored operation codes as independent variables. However, for convenience of data transmission and reception, a function for limiting and generating the number of digits of an operation code and limiting the number of digits of an authentication code or an authentication request code generated based on the limited number of digits may be determined.

The following Table 1 is an example of an operation code list, and a function for generating an authentication code or an authentication request code using a corresponding operation code list has been set such that the number of digits of an authentication code or an authentication request code is uniformly managed:

TABLE 1

| | |
|---|---|
| x1 | 435 |
| x2 | 296 |
| x3 | 274 |
| x4 | 135 |

In this case, the code generation unit 39 is set such that x1, x2, x3 and x4 are determined to be natural numbers in the range of 0 to 999. In this case, if a function used for the authentication unit 35 to generate an authentication code and a function used for the control unit 21 or the microcomputer 13 to generate an authentication request code are identically set to ‘y=1000+x1+x2+x3+x4’ in advance, a data packet can be easily generated and managed when the terminal 20 sends the authentication request code to the authentication server 30 because the generated authentication request code remains a four-digit natural number.

Furthermore, if a new single operation code, for example, “997,” is newly registered in the illustrated operation code list, the illustrated operation code list may be updated by deleting the oldest registered value x1 from the operation code list, shifting the remaining operation codes forward by one and then writing the shifted operation codes, and writing the new single operation code last, as follows:

TABLE 2

| | |
|---|---|
| x1 | 296 |
| x2 | 274 |
| x3 | 135 |
| x4 | 997 |

In this case, when the code management unit 37 generates an operation code, the time at which the corresponding operation code was generated may be recorded along with the operation code. Furthermore, when operation codes are recorded in the operation code list of the authentication medium 10, the times at which the operation codes were generated by the code management unit 37 may be recorded along with the operation codes, or the times at which the operation codes are recorded on the authentication medium 10 may be recorded along with the operation codes. In such a case, since the time at which each of the operation codes was generated or the time at which the operation code was recorded on the authentication server 30 and the authentication medium 10 are also recorded, whether or not the corresponding operation codes may be used to generate an authentication code may be differently determined depending on whether or not the time corresponding to each of the operation codes recorded on the authentication server 30 and the time corresponding to each of the operation codes recorded on the authentication medium 10 falls within an error range.

For example, in the case where five operation codes generated at different times are recorded in the operation code list of the authentication server 30 and five operation codes generated at different times are also recorded in the operation code list of the authentication medium 10, if an authentication code or an authentication request code is computed using three operation codes that belong to the five operation codes and that were recorded first, the authentication server 30 compares the times at which the respective operation codes were recorded with each other in order of registration of the operation codes in the two operation code lists. Accordingly, for example, if the difference between the times at which the five operation codes were recorded on the authentication server 30 and the authentication medium 10 falls within an error range, but the difference between the times at which the third operation codes recorded on the authentication server 30 and the authentication medium 10, respectively, exceeds the error range, the authentication server 30 and the authentication medium 10 may compute an authentication code and an authentication request code using the first, second and fourth operation codes other than the third operation codes whose time difference exceeds the error range.

An authentication method using such an authentication system according to an embodiment of the present invention is first started from step S10 of the terminal 20 receiving an authentication command from a user, as shown in FIG. 5.

Furthermore, in response to an authentication command, the control unit 21 directly accesses the memory 15 of the authentication medium 10 through the connection unit 23, reads an operation code list from the memory 15, and generates an authentication request code using the read operation code list, or the control unit 21 notifies the microcomputer 13 that the authentication command has been detected through the connection unit 23, so that the microcomputer 13 accesses the memory 15, reads the operation code list from the memory 15, and generates authentication request code using the read operation code list (S15). In this case, the operation code list recorded in the memory 15 will be hereinafter described as a “first operation code list.” Furthermore, an operation code list recorded in the authentication server 30 will be hereinafter described as a “second operation code list.”

After the authentication request code has been generated, the terminal 20 sends an authentication request signal, including the authentication request code, to the authentication server 30 at step S20.

In response thereto, the authentication server 30 generates an authentication code using the second operation code list stored in the code management unit 37 at step S25. In this case, at the step of generating the authentication code, a function identical to that used to generate the authentication request code is used.

Furthermore, the authentication unit 35 of the authentication server 30 compares the authentication request code received from the terminal 20 with the computed authentication code at step S30.

If, as a result of the comparison, the authentication request code received from the terminal 20 is found to be identical to the authentication code recorded on the authentication server 30, the code generation unit 39 increases the number of authentications n that have been performed by 1 at step S35. That is, when a single authentication ranging from step S10 to step S30 is performed, 1 is added to the existing cumulative number of authentications that have been performed.

Furthermore, the code generation unit 39 compares the number of authentications n increased by 1 with a predetermined constant k in order to determine whether or not the number of authentications n increased by 1 is identical to the predetermined constant k (S40). In this case, k is a natural number equal to or larger than 1.

If it is determined at step S40 that the authentication number n is identical to k, the code generation unit 39 generates a new operation code, updates the second operation code list so that the newly generated operation code is included in the second operation code list managed by the code management unit 37, and also sends the newly generated operation code to the terminal 20 at step S45.

Thereafter, the code generation unit 39 modifies the number of authentications n from k to 0 at step S50. This step is performed to incorporate a predetermined cycle into the number of authentications based on which the second operation code list is updated.

Furthermore, the terminal 20 which has received the new operation code from the code generation unit 39 records the new operation code in the first operation code list so that the first operation code list is updated (S55). This may be performed by the control unit 21 of the terminal 20 or the microcomputer 13 of the authentication medium 10.

Furthermore, as a result of the success of the authentication requested by the terminal 20, the service provision unit 31 may directly generate the data of service according to the authenticated right, and may send the data to the terminal 20 through the transmission and reception unit 33 or may provide another server 40 with the results of the successful authentication so that a service based on the authenticated right that has been requested by the terminal 20 may be provided to the terminal 20 at step S60.

Meanwhile, if the number of authentications n is found to have not reached k at step S40, the operation code list update process from step S35 to step S55 is omitted, and step S60 is performed.

Furthermore, if the authentication request code received from the terminal 20 at step S30 is not identical to the authentication code, it is determined that the authentication has failed, and thus an authentication failure message is sent to the terminal 20 at step S70.

In this case, if the authentication medium 10 includes the microcomputer 13, such as an integrated circuit card, when a user's authentication command input to the terminal 20 is detected at step S10, the terminal 20 receives an additional password from the user and sends the additional password to the authentication medium 10. The microcomputer 13 of the authentication medium 10 may compare the received password with a password previously stored in the memory 15, and may perform steps subsequent to step S15 only if, as a result of the comparison, it is determined there is identity.

It will be appreciated by those skilled in the art to which the present invention pertains will appreciate that the present invention may be practiced in other specific forms without changing the technical spirit or essential characteristics of the present invention. Accordingly, the aforementioned embodiments should be construed as being only illustrative, not as being restrictive, from all aspects. The scope of the present invention is defined by the following claims, rather than the detailed description, and all variations or modifications derived from the meanings and scope of the claims and their equivalents should be construed as being included in the scope of the present invention.

What is claimed is:

1. An authentication server for exchanging data with a plurality of terminals over a network and authenticating a right to access an account in response to a request from the terminal, the authentication server comprising:
an authentication unit for computing an authentication code using a predetermined function using one or more operation codes recorded on an operation code list as independent variables when an authentication request for a specific account is received from the terminal, comparing the computed authentication code with an authentication request code included in an authentication request received from the terminal, and authenticating a right to access the specific account only if the computed authentication code is identical to an authentication request code;
a code generation unit for generating one or more new operation codes whenever the authentication unit performs a predetermined number of authentications on the specific account and sending the one or more new operation codes to the terminal that has requested the authentication; and
a code management unit for recording the generated operation codes on an operation code list of the corresponding account when the new operation codes are generated by the code generation unit and selectively deleting at least some of existing operation codes if necessary;
wherein the code management unit matches the operation codes, included in the operation code list, with the respective independent variables included in the function, assigns a predetermined sequential position to each of the independent variables, and sequentially matches the operation codes with the respective independent variables according to a predetermined sequence whenever a new operation code is generated.

2. The authentication server of claim 1, wherein the predetermined number of authentications is 1.

3. The authentication server of claim 1, wherein:
the operation codes are two or more in number; and
the function is a function for selecting one from among the two or more operation codes.

4. The authentication server of claim 1, further comprising a transmission and reception unit for encoding the operation codes newly generated by the code generation unit, sending the encoded operation codes to the terminal, receiving the authentication request code encoded and transmitted by the terminal, and decoding the received authentication request code.

5. An authentication medium for accessing a terminal provided with an authentication service by an authentication server and authenticating a right to access an account, the authentication medium comprising:
an interface for exchanging data with the terminal and receiving one or more new operation codes when the one or more new operation codes are transmitted by the authentication server through the terminal;
memory for storing an operation code list in which one or more of the operation codes received through the interface are sequentially recorded; and
a microcomputer for computing an authentication request code using a function using the one or more operation codes included in the operation code list stored in the memory as independent variables and sending the computed authentication request code to the authentication server through the interface;
wherein the microcomputer records the one or more operation codes received by the interface in the operation code list and selectively deletes at least some of existing operation codes.

6. The authentication medium of claim 5, wherein:
the operation code is x, x being a character string including one or more of numbers and alphabetical letters;
the authentication request code is y; and
the function is y=x.

7. The authentication medium of claim 7 or 8, wherein the authentication medium is an integrated circuit card including an integrated processor and integrated memory.

8. The authentication medium of claim 5, wherein the microcomputer receives a password from the terminal, computes the authentication request code using the function using the one or more operation codes included in the operation code list stored in the memory as the independent variables only if the received password is identical to a password stored in the memory, and sends the computed authentication request code to the authentication server through the interface.

9. The authentication medium of claim 8, wherein the interface encodes the authentication request code, sends the encoded authentication request code to the terminal, and decodes the operation codes received from the terminal.

10. An authentication method in a system including an authentication medium for storing data required for authentication, a terminal for requesting authentication using an authentication request code generated based on the data stored in the authentication medium, and an authentication server for comparing the authentication request code with an authentication code in response to the request from the terminal and selectively performing an authentication procedure, the authentication method comprising:
(A) generating, by the authentication medium or the terminal, the authentication request code using a predetermined first function using operation codes included in a first operation code list stored in the authentication medium as independent variables;
(B) sending, by the terminal, an authentication request, including the authentication request code, to the authentication server;
(C) comparing, by the authentication server that has received the authentication request, an authentication code, generated using a second function identical to the first function and using operation codes included in a second operation code list stored in the authentication server as independent variables, with the authentication request code and selectively performing the authentication;
(D) generating, by the authentication server, a new operation code if the authentication is successful in the authentication server, sending the new operation code to the terminal, recording an operation code identical to the new operation code transmitted by the terminal in the second operation code list in a time sequence in which the new operation code was generated, and simultaneously deleting an oldest operation code from the second operation code list; and
(E) transferring, by the terminal that has received the new operation code from the authentication server, the received new operation code to the authentication medium, recording, by the terminal or the authentication medium, the new operation code in the first operation code list in a time sequence in which the new operation code was received, and selectively deleting at least some of existing operation codes from the first operation code list if necessary.

11. The authentication method of claim 10, wherein, at step (D), the authentication server uses a character string generated by arranging a plurality of characters at predetermined digit positions, as the new operation code.

12. The authentication method of claim 10 or 11, wherein:
a number of operation codes recorded in each of the first and second operation code lists is one or more and identically maintained, and each of the first and second functions is a function for computing dependent variables by alternatively selecting any one of one or more independent variables or performing computation using at least some of the one or more independent variables.

13. The authentication method of claim 12, wherein:
each of the first and second operation code lists comprises a single operation code, and each of the first and second functions is a function for computing the dependent variables identical to the independent variables using the single operation code as a single independent variable.

14. The authentication method of claim 10, wherein each of the operation codes recorded on the first and second operation code lists is recorded along with a time at which the operation code was recorded;
further comprising, before step (A), comparing times at which the operation codes included in the first operation code list were recorded with respective times at which the operation codes included in the second operation code list were recorded, and deleting operation codes having differences between the times recorded on the first and second operation code lists from the first and second operation code lists.
